(19) United States
(12) Patent Application Publication
(10) Pub. No.: US 2014/0335791 A1
(43) Pub. Date: Nov. 13, 2014

(54) METHOD AND DEVICE FOR PROVIDING A PROXIMITY SERVICE IN A WIRELESS COMMUNICATION SYSTEM

(71) Applicant: LG ELECTRONICS INC., Seoul (KR)

(72) Inventors: Laeyoung Kim, Anyang-si (KR); Jaehyun Kim, Anyang-si (KR); Taehyeon Kim, Anyang-si (KR); Hyunsook Kim, Anyang-si (KR)

(73) Assignee: LG ELECTRONICS INC., Seoul (KR)

(21) Appl. No.: 14/364,288

(22) PCT Filed: Dec. 13, 2012
(86) PCT No.: PCT/KR2012/010841

§ 371 Date: Jun. 10, 2014

Related U.S. Application Data
(60) Provisional application No. 61/570,239, filed on Dec. 13, 2011.
(60) Provisional application No. 61/570,242, filed on Dec. 13, 2011.
(60) Provisional application No. 61/578,244, filed on Dec. 21, 2011.
(60) Provisional application No. 61/578,245, filed on Dec. 21, 2011.
(60) Provisional application No. 61/582,414, filed on Jan. 2, 2012.
(60) Provisional application No. 61/582,415, filed on Jan. 2, 2012.

(51) Int. Cl. H04W 4/00; H04W 8/24

(52) U.S. Cl. CPC H04W 4/008; H04W 8/24
USPC 455/41.2

(57) ABSTRACT

The present invention relates to a wireless communication system, and more particularly, to a method and device for providing a proximity service. According to one embodiment of the present invention, the method for providing a proximity service (ProSe) for user equipment in a wireless communication system may include: transmitting ProSe capability related information on the user equipment to a network node; receiving information on the provision of a ProSe related network from the network node; determining the ProSe usage of the user equipment based on the ProSe capability related information on the user equipment and/or the received information on the provision of a ProSe related network; and transmitting the determination result of the ProSe usage of the user equipment to the network node.

### TECHNICAL FIELD

The present invention relates to a wireless communication system and, more particularly, to a method and apparatus for providing proximity service.

### BACKGROUND ART

Proximity service (ProSe) refers to a scheme for supporting communication between devices located physically close to each other. Specifically, ProSe is aimed to discover an application operating devices which are in proximity and, ultimately, to support exchange of data related to the application. For example, it may be considered that ProSe is applied to applications such as social network services (SNS), commerce, and games.

ProSe may be also called device-to-device (D2D) communication. That is, ProSe refers to a communication scheme for establishing a direct link between a plurality of devices (e.g., user equipments (UEs)) and thus directly exchanging user data (e.g., audio, multimedia data, etc.) between the devices without going via a network. ProSe communication may include UE-to-UE communication, Peer-to-Peer communication, etc. In addition, ProSe communication may be applied to Machine-to-Machine (M2M) communication, Machine Type Communication (MTC), etc. Accordingly, ProSe is considered as one solution to reduce the burden of a base station due to rapidly increasing data traffic. Besides, by adopting ProSe, effects such as reduction in procedures of a base station, reduction in power consumption of devices which participate in ProSe, increase in data transmission speed, increase in network capacity, load distribution, cell coverage expansion, etc. can be expected.

While adoption of ProSe is demanded as described above, a mechanism for supporting and controlling ProSe is not specifically prepared.

### DISCLOSURE

### Technical Problem

An object of the present invention devised to solve the problem lies in a specific method of a control mechanism for implementing ProSe. Another object of the present invention devised to solve the problem lies in a method for efficiently supporting ProSe by reducing network loads associated with ProSe related control signaling. A further object of the present invention devised to solve the problem lies in a method for providing various proximity-based services to users by providing an efficient communication scheme between devices in proximity

It is to be understood that both the foregoing general description and the following detailed description of the present invention are exemplary and explanatory and are intended to provide further explanation of the invention as claimed.

### Technical Solution

The object of the present invention can be achieved by providing a method for proximity service (ProSe) of a user equipment (UE) in a wireless communication system, the method including transmitting ProSe capability related information of the UE to a network node, receiving ProSe related network providing information from the network node, determining ProSe availability of the UE based on one or more of the ProSe capability related information the UE and the received ProSe related network providing information, and transmitting the determination result about the ProSe availability of the UE to the network node.

In another aspect of the present invention, provided herein is a method for supporting proximity service (ProSe) of a user equipment (UE) by a network node in a wireless communication system, the method including receiving ProSe capability related information of the UE from the UE, determining ProSe availability of the UE based on one or more of the ProSe capability related information the UE, subscriber information of the UE, and operator policy information, transmitting the determination result as ProSe related network providing information, and receiving information about the ProSe availability of the UE, which is determined based on one or more of the ProSe capability related information the UE and the ProSe related network providing information, from the UE.

In another aspect of the present invention, provided herein is a user equipment (UE) relate to proximity service (ProSe) in a wireless communication system, the UE including a transceiver module for transmitting and receiving signals to and from an external device, and a processor for controlling the transceiver module, wherein the processor is configured to transmit ProSe capability related information of the UE to a network node using the transceiver module, receive ProSe related network providing information from the network node using the transceiver module, determine ProSe availability of the UE based on one or more of the ProSe capability related information the UE and the received ProSe related network providing information, and transmit the determination result about the ProSe availability of the UE to the network node using the transceiver module.

In another aspect of the present invention, provided herein is a network node for supporting proximity service (ProSe) of a user equipment (UE) in a wireless communication system, the network node including a transceiver module for transmitting and receiving signals to and from an external device, and a processor for controlling the transceiver module, wherein the processor is configured to receive ProSe capability related information of the UE from the UE using the transceiver module, determine ProSe availability of the UE based on one or more of the ProSe capability related information the UE, subscriber information of the UE, and operator policy information, transmit the determination result as ProSe related network providing information using the transceiver module, and receive information about the ProSe availability of the UE, which is determined based on one or more of the ProSe capability related information the UE and the ProSe related network providing information, from the UE using the transceiver module.

The followings may be commonly applied to the above methods, the UE and the network node.

The ProSe capability related information of the UE may include one or more of information indicating one or more ProSe capabilities of the UE, and information indicating enabled or disabled state of each of the ProSe capabilities.

The ProSe capability related information may be defined with one or more granularities among a media or content type, an Access Point Name (APN), a QoS (Quality of Service) Class Identifier (QCI), a bearer or connection type, an application type, a service type, a destination domain, an opposite UE for communication, and a Closed Subscriber Group (CSG).

The ProSe capability related information of the UE may be included in an attach request message, a Tracking Area Update (TAU) request message, or a Routing Area Update (RAU) request message transmitted to the network node.

The ProSe capability related information of the UE may be stored in one or more of the network node, a Home Subscriber Server (HSS) and a ProSe server.

The ProSe related network providing information may be determined by the network node based on one or more of the ProSe capability related information of the UE, subscriber information of the UE, and operator policy information.

The ProSe related network providing information may include one or more of information about ProSe permissibility of the UE, information about whether a network has a ProSe capability, information indicating to enable a ProSe capability of the UE and related information thereof, indication information to disable the ProSe capability of the UE and related information thereof, ProSe related operator policy information, ProSe related information for a roaming UE, information about conditions for performing of ProSe by the UE, and indication information about operations involved with performing of ProSe by the UE.

The ProSe related network providing information may be stored in one or more of the network node, a Home Subscriber Server (HSS) and a ProSe server.

The ProSe related network providing information may be included in an attach response message, a TAU response message, or a RAU response message received from the network node.

The ProSe availability of the UE may be determined based on information previously configured in the UE.

The determination result about the ProSe availability of the UE may be included in an attach complete message, a TAU complete message, or a RAU complete message transmitted to the network node.

The network node may be one of a Mobility Management Entity (MME), a Serving GPRS (General Packet Radio Service) Supporting Node (SGSN) and a ProSe server.

It is to be understood that both the foregoing general description and the following detailed description of the present invention are exemplary and explanatory and are intended to provide further explanation of the invention as claimed.

### Advantageous Effects

According to the present invention, a specific method of a control mechanism for implementing ProSe may be provided. Further, a method for efficiently supporting ProSe by reducing network loads associated with ProSe related control signaling may be provided. Besides, a method for providing various proximity-based services to users by providing an efficient communication scheme between devices in proximity may be provided.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a view schematically illustrating the architecture of an Evolved Packet System (EPS) including an Evolved Packet Core (EPC);

FIG. 2 is a view illustrating a default data path for communication between two UEs in an EPS;

FIG. 3 is a view illustrating a direct mode data path between two UEs based on ProSe;

FIG. 4 is a view illustrating a locally-routed data path between two UEs based on ProSe;

FIG. 5 is a flowchart for describing ProSe related control signaling according to an embodiment of the present invention; and

FIG. 6 is a view illustrating the configurations of a UE and a network node according to an embodiment of the present invention.

### BEST MODE

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

Specific terms used in the following description are provided to aid in understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. In addition, like reference numerals denote like elements in the drawings throughout the specification.

The embodiments of the present invention can be supported by standard documents disclosed for at least one of radio access systems such as Institute of Electrical and Electronics Engineers (IEEE) 802, 3rd Generation Partnership Project (3GPP), 3GPP Long Term Evolution (3GPP LTE), LTE-Advanced (LTE-A), and 3GPP2 systems. For steps or parts of which description is omitted to clarify the technical features of the present invention, reference may be made to these documents. Further, all terms as set forth herein can be explained by the standard documents.

The following technology can be used in various radio access systems. For clarity, the present disclosure focuses on 3GPP LTE and LTE-A systems. However, the technical features of the present invention are not limited thereto.

Terms used in the present specification are defined as follows.
UMTS (Universal Mobile Telecommunication System): A 3rd generation mobile communication technology based on Global System for Mobile communication (GSM), which is developed by 3GPP.
EPS (Evolved Packet System): A network system configured with an access network such as Evolved Packet Core (EPC), which is an Internet Protocol (IP)-based packet switched core network, LTE, UMTS Terrestrial Radio Access Network (UTRAN), etc. EPS is a network evolved from UMTS.
NodeB: A base station of a GSM/EDGE (Enhanced Data rates for GSM Evolution) Radio Access Network (GERAN)/UTRAN, which is installed outdoor and has a coverage corresponding to a macro cell.
eNodeB (evolved Node B): A base station of an LTE network, which is installed outdoor and has a coverage corresponding to a macro cell.
UE (User equipment): A user device. The UE may be referred to as a terminal, a mobile equipment (ME), a mobile station (MS), etc. In addition, the UE may be a portable device such as a laptop computer, a mobile phone, a personal digital assistant (PDA), a smartphone or a multimedia device, or a non-portable device such as a vehicle mounted device. The UE is capable of performing communication using a 3GPP spectrum such as LTE and/or a non-3GPP spectrum such as WiFi or public safety spectrum.
ProSe (Proximity service or Proximity-based service): Service enabling discovery and direct communication/communication via a base station/communication via a third device between physically adjacent devices. In this case, user plane data is exchanged through a direct data path without a 3GPP core network (e.g., EPC).
Proximity: Proximity of a UE to another UE is determined based on whether a predetermined proximity condition is satisfied. Different proximity conditions can be given for ProSe discovery and ProSe communication. The proximity condition may be configured to be controlled by an operator.
ProSe Discovery: A process that identifies that a UE is in proximity of another, using Evolved Universal Terrestrial Radio Access (E-UTRA).
ProSe Communication: A communication between UEs in proximity by means of a communication path established between the UEs. The communication path can be established directly between the UEs or routed via a local base station(s) (e.g., eNodeB(s)).
ProSe-enabled UE: A UE supporting ProSe discovery and/or ProSe communication.
ProSe-enabled Network: A network supporting ProSe discovery and/or ProSe communication.
RAN (Radio Access Network): A unit including a NodeB, an eNodeB and a radio network controller (RNC) for controlling the NodeB and the eNodeB in a 3GPP network. The RAN is present between a UE and a core network and provides connection to the core network.
HLR (Home Location Register)/HSS (Home Subscriber Server): A database having subscriber information in a 3GPP network. HSS may perform functions such as configuration storage, identity management and user state storage.
RANAP (RAN Application Part): An interface between RAN and a node (e.g., Mobility Management Entity (MME)/Serving GPRS (General Packet Radio Service) Supporting Node (SGSN)/Mobile Switching Center (MSC)) for controlling a core network.
PLMN (Public Land Mobile Network): A network configured to provide mobile communication service to individuals. PLMN can be configured on an operator basis.
NAS (non-access stratum): A functional layer for signaling and exchanging of traffic messages between a UE and a core network in a UMTS protocol stack. NAS supports mobility of the UE and supports a session management procedure for establishing and maintaining IP connection between a UE and a Packet Data Network GateWay (PDN GW).
Home NodeB (HNB): A base station of a UMTS network, which is mounted indoors and coverage of which forms a micro cell.
Home eNodeB (HeNB): A base station of an EPS network, which is mounted indoors and coverage of which forms a micro cell.
HNB (Home NodeB): Customer Premises Equipment (CPE) for providing UTRAN coverage. For details thereof, reference can be made to 3GPP TS 25.467.
HeNB (Home eNodeB): CPE for providing Evolved-UTRAN (E-UTRAN) coverage. For details thereof, reference can be made to 3GPP TS 36.300.
CSG (Closed Subscriber Group): A group of subscribers who are permitted to access one or more CSG cells of a Public Land Mobile Network (PLMN) as members of a CSG of a H(e)NB.
LIPA (Local IP Access): An access for an IP capable UE connected via a H(e)NB to another IP capable entity in the same residential/enterprise IP network. LIPA traffic is expected to not traverse a mobile operator's network. A 3GPP Release-10 system provides an access via a H(e)NB to resources of a local network (e.g., network located at the customer's home or enterprise).
SIPTO (Selected IP Traffic Offload): In a 3GPP Release-10 system, an operator selects a Packet data network GateWay (PGW) which is physically close to a UE in an EPC network and supports handover of user traffic.
PDN (Packet Data Network) Connection: A logical connection between a UE indicated by a single IP address (e.g., single IPv4 address and/or single IPv6 prefix) and a PDN indicated by an Access Point Name (APN).

EPC (Evolved Packet Core)

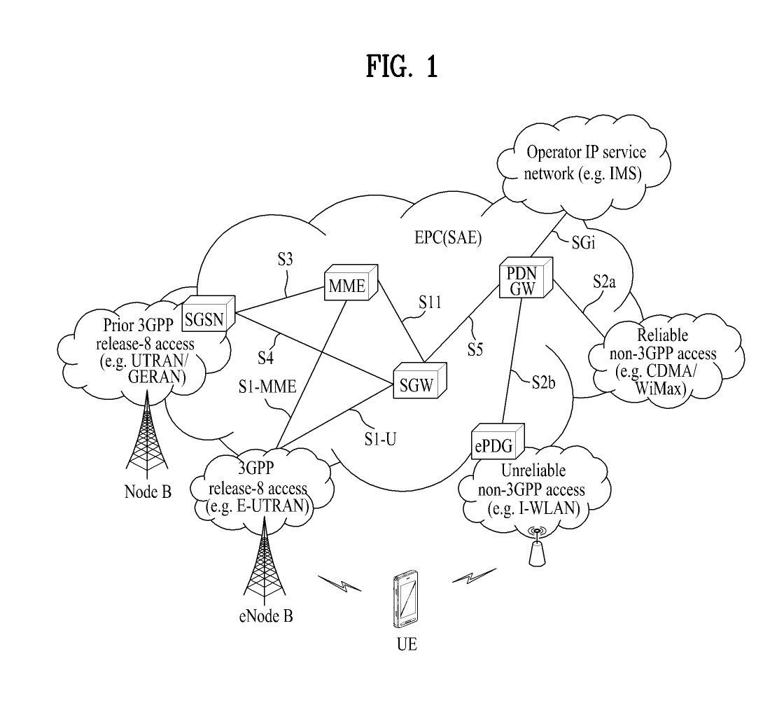

FIG. 1 is a view schematically illustrating the architecture of an Evolved Packet

System (EPS) including an Evolved Packet Core (EPC).

The EPC is a core element of System Architecture Evolution (SAE) for improving the performance of 3GPP technology. SAE corresponds to a study item for deciding a network structure supporting mobility among various types of network. SAE aims to provide, for example, an optimized packet-based system which supports various radio access technologies based on IP and provides improved data transfer capabilities.

Specifically, the EPC is a core network of an IP mobile communication system for a 3GPP LTE system and may support packet-based real-time and non-real-time services. In a legacy mobile communication system (e.g., 2nd or 3rd generation mobile communication system), a core network function is implemented through two separated sub-domains, e.g., circuit-switched (CS) sub-domain for sound and packet-switched (PS) sub-domain for data. However, in a 3GPP LTE system which is evolved from the 3rd generation communication system, the CS and PS sub-domains are unified into a single IP domain. For example, in the 3GPP LTE system, IP-capable UEs can be connected via an IP-based base station (e.g., eNodeB (evolved Node B)), an EPC, an application domain (e.g., IMS (IP Multimedia Subsystem)). That is, the EPC is a structure inevitably required to implement end-to-end IP service.

The EPC may include various components and FIG. 1 illustrates a few of the components, e.g., Serving GateWay (SGW), Packet Data Network GateWay (PDN GW), Mobility Management Entity (MME), Serving GPRS (General Packet Radio Service) Supporting Node (SGSN), and enhanced Packet Data Gateway (ePDG).

The SGW operates as a boundary point between a Radio Access Network (RAN) and a core network and is an element which performs a function for maintaining a data path between an eNodeB and a PDG GW. In addition, if a UE moves across an area served by an eNodeB, the SGW serves as a local mobility anchor point. That is, packets may be routed via the SGW for mobility in an Evolved-UMTS (Universal Mobile Telecommunications System) Terrestrial Radio Access Network (E-UTRAN) defined after 3GPP Release-8. Further, the SGW may serve as an anchor point for mobility management with another 3GPP network such as RAN defined before 3GPP Release-8, e.g., UTRAN or GSM (Global System for Mobile communication)/EDGE (Enhanced Data rates for GSM Evolution) Radio Access Network (GERAN).

The PDN GW (or P-GW) corresponds to a termination point of a data interface directed to a packet data network. The PDN GW may support policy enforcement features, packet filtering and charging support. In addition, the PDN GW may serve as an anchor point for mobility management with a 3GPP network and a non-3GPP network (e.g., untrusted network such as Interworking Wireless Local Area Network (I-WLAN) and trusted network such as Code Division Multiple Access (CDMA) or WiMax).

Although the SGW and the PDN GW are configured as separate gateways in the network architecture of FIG. 1, the two gateways may be implemented according to a single gateway configuration option.

The MME performs signaling and control functions to support access of a UE for network connection, network resource allocation, tracking, paging, roaming and handover. The MME controls control plane functions related to subscriber and session management. The MME manages a large number of eNodeBs and performs signaling for selection of a typical gateway for handover to another 2G/3G network. In addition, the MME performs security procedures, terminal-to-network session handling, idle terminal location management, etc.

The SGSN handles all packet data such as mobility management and authentication of a user for another 3GPP network (e.g., GPRS network).

The ePDG serves as a security node for an untrusted non-3GPP network (e.g., I-WLAN, Wi-Fi hotspot, etc.).

As described above in relation to FIG. 1, an IP-capable UE may access an IP service network (e.g., IMS) provided by an operator, via various elements in the EPC based on non-3GPP access as well as 3GPP access.

FIG. 1 also illustrates various reference points (e.g., S1-U, S1-MME, etc.). In the 3GPP system, a conceptual link connecting two functions of different functional entities of E-UTRAN and EPC is defined as a reference point. Table 1 lists the reference points illustrated in FIG. 1. In addition to the examples of Table 1, various reference points may be present according to network architectures.

TABLE 1

| Reference | |
|---|---|
| Point | Description |
| S1-MME | Reference point for the control plane protocol between E-UTRAN and |
| | MME |
| S1-U | Reference point between E-UTRAN and Serving GW for the per bearer |
| | user plane tunneling and inter eNodeB path switching during handover |
| S3 | It enables user and bearer information exchange for inter 3GPP access |
| | network mobility in idle and/or active state. This reference point can be |
| | used intra-PLMN or inter-PLMN (e.g. in the case of Inter-PLMN HO). |
| S4 | It provides related control and mobility support between GPRS Core and |
| | the 3GPP Anchor function of Serving GW. In addition, if Direct Tunnel |
| | is not established, it provides the user plane tunneling. |
| S5 | It provides user plane tunneling and tunnel management between Serving |
| | GW and PDN GW. It is used for Serving GW relocation due to UE |
| | mobility and if the Serving GW needs to connect to a non-collocated |
| | PDN GW for the required PDN connectivity. |
| S11 | Reference point between MME and Serving GW |
| SGi | It is the reference point between the PDN GW and the packet data |
| | network. Packet data network may be an operator external public or |
| | private packet data network or an intra operator packet data network, e.g. |
| | for provision of IMS services. This reference point corresponds to Gi for |
| | 3GPP accesses. |

Among the reference points illustrated in FIG. 1, S2a and S2b correspond to non-3GPP interfaces. S2a is a reference point for providing a user plane with related control and mobility support between the trusted non-3GPP access and the PDNGW. S2b is a reference point for providing a user plane with related control and mobility support between the ePDG and the PDNGW.

Control Mechanism for Providing Proximity Service (ProSe)

The present invention proposes a control mechanism for supporting proximity service (ProSe) or D2D service in a mobile communication system such as 3GPP Evolved Packet System (EPS).

Due to increase in user demands related to social network service (SNS), etc., demands for detection/discovery between physically adjacent users/devices and special application/service (e.g., proximity-based application/service) has appeared. Even in a 3GPP mobile communication system, potential use cases and scenarios of ProSe and potential service requirements to provide such service are under discussion.

The potential use cases of ProSe may include commercial/social service, network offloading, public safety, integration of current infrastructure services (to assure the consistency of the user experience including reachability and mobility aspects). Additionally, use cases and potential requirements for public safety in the case of absence of EUTRAN coverage (subject to regional regulation and operator policy, and limited to specific public-safety designated frequency bands and terminals) are under discussion.

In particular, the scope of discussion of ProSe by 3GPP assumes that proximity-based application/service is provided via LTE or WLAN, and that discovery and communication are performed between devices under the control of an operator/network.

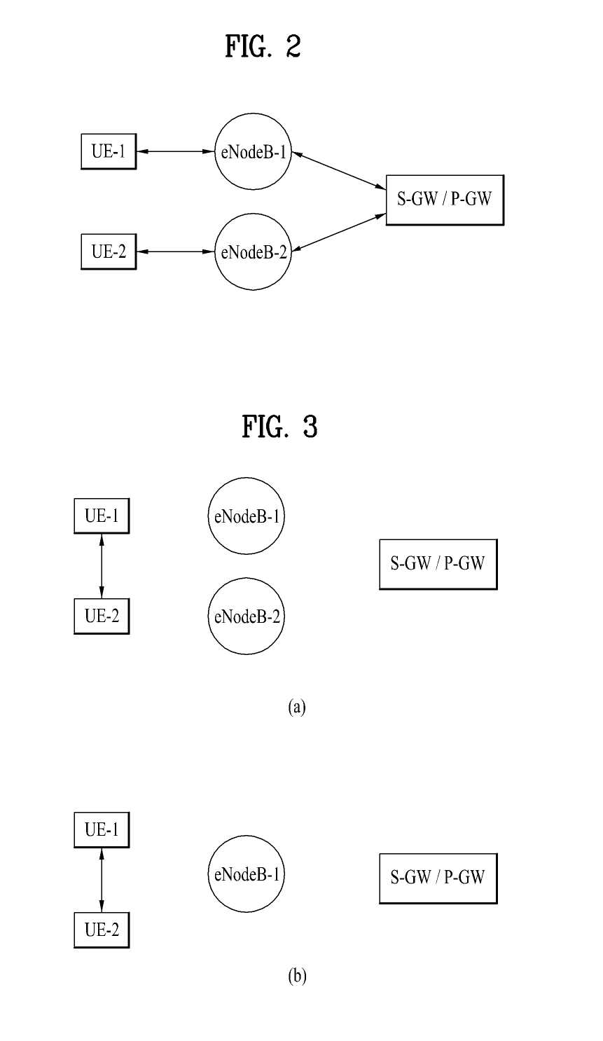

FIG. 2 is a view illustrating a default data path for communication between two UEs in an EPS. That is, FIG. 2 illustrates an exemplary data path between UE-1 and UE-2 in a general case of no ProSe between UE-1 and UE-2. This default path goes via a base station (e.g., eNodeB or Home eNodeB) and gateway nodes (e.g., EPC or operator network). For example, as illustrated in FIG. 2, when UE-1 and UE-2 exchange data, data from UE-1 may be transmitted via eNodeB-1, S-GW/P-GW, and eNodeB-2 to UE-2 and, likewise, data from UE-2 may be transmitted via eNodeB-2, S-GW/P-GW, and eNodeB-1 to UE-1. Although UE-1 and UE-2 are camped on different eNodeBs in FIG. 2, UE-1 and UE-2 may be camped on the same eNodeB. In addition, although the two UEs are served by the same S-GW and P-GW in FIG. 2, various combinations of services are allowed here. For example, the UEs may be served by the same S-GW and different P-GWs, by different S-GWs and the same P-GW, or by different S-GWs and different P-GWs.

In the present invention, this default data path may be referred to as an infrastructure path, infrastructure data path, or infrastructure communication path. In addition, communication through the infrastructure data path may be referred to as infrastructure communication.

FIG. 3 is a view illustrating a direct mode data path between two UEs based on ProSe. This direct mode communication path does not go via a base station (e.g., eNodeB or Home eNodeB) and gateway nodes (e.g., EPC).

FIG. 3(a) illustrates an exemplary case in which UE-1 and UE-2 are camped on different eNodeBs (e.g., eNodeB-1 and eNodeB-2) and exchange data via a direct mode communication path. FIG. 3(b) illustrates an exemplary case in which UE-1 and UE-2 are camped on the same eNodeB (e.g., eNodeB-1) and exchange data via a direct mode communication path.

It should be noted that a data path of a user plane is directly established between UEs without going via a base station or a gateway node as illustrated in FIG. 3, but a control plane path can be established via a base station and a core network. Control information exchanged through the control plane path may be information about session management, authentication, authorization, security, charging, etc. In the case of ProSe communication between UEs served by different eNodeBs as illustrated in FIG. 3(a), control information for UE-1 may be exchanged via eNodeB-1 with a control node (e.g., MME) of a core network, and control information for UE-2 may be exchanged via eNodeB-2 with a control node (e.g., MME) of a core network. In the case of ProSe communication between UEs served by the same eNodeB as illustrated in FIG. 3(b), control information for UE-1 and UE-2 may be exchanged via eNodeB-1 with a control node (e.g., MME) of a core network.

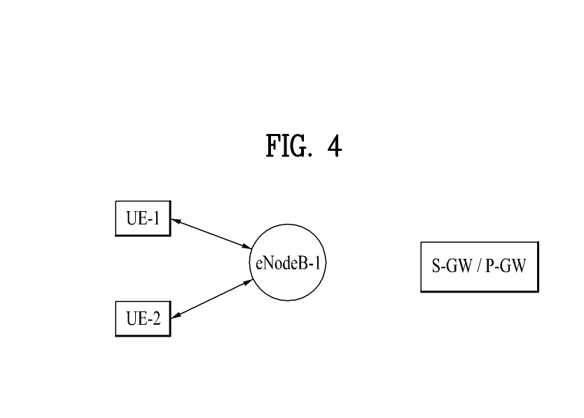

FIG. 4 is a view illustrating a locally-routed data path between two UEs based on ProSe. As illustrated in FIG. 4, a ProSe communication data path between UE-1 and UE-2 is established via eNodeB-1 but does not go via a gateway node (e.g., EPC) operated by an operator. For a control plane path, if a locally-routed data path is established between UEs served by the same eNodeB as illustrated in FIG. 4, control information for UE-1 and UE-2 may be exchanged via eNodeB-1 with a control node (e.g., MME) of a core network.

In the present invention, the communication path described above in relation to FIGS. 3 and 4 may be referred to as a direct data path, data path for ProSe, ProSe-based data path, or ProSe communication path. In addition, communication through this direct data path may be referred to as direct communication, ProSe communication, or ProSe-based communication.

As described above, only potential use cases and requirements of ProSe, basic data paths, and control paths are under discussion, and details for the architecture and operation of a 3GPP network for supporting ProSe are not prepared. The present invention proposes specific examples of control plane signaling for enabling control of ProSe by an operator/network.

Control Plane Mechanism for Supporting ProSe

The present invention proposes control plane mechanisms required to perform ProSe.

Specifically, the present invention proposes a scheme for providing information about device capability and information about enable/disabled state of the device capability to a network by a UE/user/subscriber/device (hereinafter collectively referred to as a UE) to receive ProSe. Further, the present invention proposes a scheme for determining whether a network supports ProSe related service, whether a UE is capable of receiving the service, etc. and providing information about the determination to the UE. Besides, the present invention proposes a scheme for determining whether a UE is capable of using ProSe, based on ProSe related information received from a network, and performing an operation for ProSe.

That is, the mechanism proposed by the present invention may include one of or a combination of two or more of a scheme for providing UE-ProSe capability related information to a network by a UE (this scheme relates to Embodiment 1), a scheme for determining whether ProSe is supported and providing related control by a network (this scheme relates to Embodiment 2), a scheme for providing ProSe related network providing information to a UE by a network (this scheme relates to Embodiment 3), a scheme for determining ProSe availability of a UE (this scheme relates to Embodiment 4), a scheme for reporting the determination result about the ProSe availability of a UE to a network (this scheme relates to Embodiment 5), and a scheme for performing a ProSe related operation by a UE (this scheme relates to Embodiment 6). A detailed description is now given of Embodiments 1 to 6.

### Embodiment 1

Embodiment 1 relates to a scheme for transmitting information about a ProSe capability of a UE and/or information indicating enable/disabled state of the ProSe capability to a network.

Specifically, to perform a ProSe operation (e.g., discovery of other UEs in proximity by a certain UE, or direct communication between UEs), a UE may transmit information about whether the UE has capability for supporting the ProSe operation, to a network. Here, the capability for the ProSe operation may be expressed as one capability or a set of a plurality of capabilities. In addition, even when the UE has capability itself for the ProSe operation, if the capability can be enabled or disabled, the UE may transmit information about enabled/disabled state of the capability to the network.

Hereinafter, ProSe capability information itself of a UE and/or enabled/disabled state information about each ProSe capability are collectively referred to as “UE-ProSe capability related information”.

The UE-ProSe capability related information may be included in a message transmitted from the UE to the network when the UE performs a typical operation such as network attach, Tracking Area Update (TAU) or Routing Area Update (RAU) and/or when the UE performs a newly defined procedure (e.g., ProSe Discovery request, etc.) for ProSe. In this case, the UE-ProSe capability related information may be transmitted to the network using a typically defined message or a newly defined message.

A network node which receives the UE-ProSe capability related information may include one or more nodes. For example, the one or more nodes may include a mobility management node such as MME or SGSN, an Authentication Authorization Accounting (AAA) server or an AAA proxy server, a server for ProSe, an Access Network Discovery and Selection Function (ANDSF) entity, an eNodeB, a gateway node such as P-GW, etc. The above network node(s) may receive the UE-ProSe capability related information directly from the UE or via another network node.

The UE-ProSe capability related information may be stored in one or more network nodes. For example, the UE-ProSe capability related information may be stored in MME as context, in HSS as subscriber information, in a third network node (e.g., server for ProSe), or in two or more of the above network nodes.

The UE-ProSe capability related information may be defined with and applied to one or more granularities. The granularities of the UE-ProSe capability related information may be configured as a media/content type, an Access Point Name (APN), a QoS (Quality of Service) Class Identifier (QCI), a bearer/connection type, an application type, a service type, a destination domain, an opposite UE for communication, a Closed Subscriber Group (CSG), etc. In addition, the UE may be determined whether to use subdivided ProSe for each granularity, or determined whether to use ProSe for a combination of two or more of the granularities. The above various granularities for the UE-ProSe capability related information are merely exemplary, and the scope of the present invention is not limited thereto. A detailed description is now given of the granularities.

The UE-ProSe capability related information may be configured per a media type or a content type (e.g., audio, video, image, text, etc.). The UE may maintain the UE-ProSe capability related information only with respect to media or contents for use of ProSe. Here, use of ProSe may mean that the UE currently uses, desires to use, capable of using, or considers to use ProSe, or a combination thereof. For example, if ProSe is not considered for audio but is considered for video, the UE-ProSe capability related information may be maintained with respect to video but may not be maintained with respect to audio. Although the media/content type is described above as an example, the technical idea that the UE-ProSe capability related information is maintained only with respect to each granularity for use of ProSe and which includes the following examples may be equally applied.

The UE-ProSe capability related information may be configured per an APN. The UE may maintain the UE-ProSe capability related information only with respect to an APN for use of ProSe. For example, if ProSe is not considered for an IMS APN for IMS service but is considered for an Internet APN, the UE-ProSe capability related information may be maintained with respect to the Internet APN but may not be maintained with respect to the IMS APN. In addition, an APN for ProSe communication may be defined and used and, in this case, the UE-ProSe capability related information may be maintained only with respect to the APN for ProSe communication.

The UE-ProSe capability related information may be configured per a QCI. The UE may maintain the UE-ProSe capability related information only with respect to a QCI for use of ProSe. For example, if ProSe is not considered for QCI=1 for conversational voice but is considered for QCI=9 for video and Transmission Control Protocol (TCP)-based service (e.g., web browsing, email, File Transfer Protocol (FTP), etc.), the UE-ProSe capability related information may be maintained with respect to QCI=9 but may not be maintained with respect to QCI=1.

The UE-ProSe capability related information may be configured per a bearer or connection type (e.g., emergency bearer, LIPA or SIPTO connection, etc.). The UE may maintain the UE-ProSe capability related information only with respect to a bearer or connection for use of ProSe. For example, if ProSe is not considered for a Guaranteed Bit Rate (GBR) bearer but is considered for a non-GBR bearer, the UE-ProSe capability related information may be maintained with respect to the non-GBR bearer but may not be maintained with respect to the GBR bearer. Otherwise, if ProSe is considered only for an emergency bearer, the UE-ProSe capability related information may be maintained with respect to the emergency bearer. Alternatively, if ProSe is considered only for an SIPTO connection, the UE-ProSe capability related information may be maintained with respect to the SIPTO connection.

The UE-ProSe capability related information may be configured per an application type. The UE may maintain the UE-ProSe capability related information only with respect to an application for use of ProSe. For example, if ProSe is not considered for application #1 but is considered for application #2, the UE-ProSe capability related information may be maintained with respect to application #2 but may not be maintained with respect to application #1.

The UE-ProSe capability related information may be configured per a service type (e.g., instant messaging service, file sharing service, public safety service, chatting service, social networking service, etc.). The UE may maintain the UE-ProSe capability related information only with respect to service (or an application(s) for providing the service) for use of ProSe. For example, if ProSe is considered for a file sharing service (or an application(s) for providing the file sharing service), the UE-ProSe capability related information may be configured for the file sharing service (or the application(s) for providing the file sharing service).

The UE-ProSe capability related information may be configured per a destination domain. The UE may maintain the UE-ProSe capability related information only with respect to a destination domain for use of ProSe. For example, if ProSe is not considered for domain a but is considered for domain b, the UE-ProSe capability related information may be maintained with respect to domain b but may not be maintained with respect to domain a.

The UE-ProSe capability related information may be configured per an ID of an opposite UE (peer) for communication, a specific contact list or a specific group. The UE may maintain the UE-ProSe capability related information only with respect to an opposite UE (or a list/group thereof) for use of ProSe. For example, if ProSe is considered only for opposite UEs included in a specific list/group, the UE-ProSe capability related information may be maintained with respect to the opposite UEs included in the specific list/group but may not be maintained with respect to opposite UEs not included in the specific list/group.

The UE-ProSe capability related information may be configured per a CSG. The UE may maintain the UE-ProSe capability related information only with respect to a CSG for use of ProSe. For example, if ProSe is considered only for opposite UEs included in a specific CSG including the UE, the UE-ProSe capability related information may be maintained with respect to the specific CSG but may not be maintained with respect to opposite UEs not included in the specific CSG.

When the UE-ProSe capability related information is configured with various granularities as described above, instead of simply not maintaining the UE-ProSe capability related information with respect to a granularity for which ProSe is not considered, a ProSe capability of the UE may be configured as being “disabled”. For example, when the UE-ProSe capability related information is configured with a granularity of QCI, the UE-ProSe capability related information may be managed for all QCIs (QCI=1˜9) and the ProSe capability of the UE may be configured as being enabled or disabled with respect to a QCI for use of ProSe. Here, the enabled or disabled state may be set by a user selection or a network indication. Meanwhile, the ProSe capability of the UE may be configured as being disabled with respect to QCIs not for use of ProSe.

Here, each UE may have a single piece of ProSe capability information and information indicating enabled/disabled state of a ProSe capability may be subdivided according to the various granularities (i.e., whether the UE has a ProSe capability itself may be configured irrespective of the granularities, and enabled/disabled state of the ProSe capability may be indicated per a subdivided granularity). Otherwise, both the ProSe capability information and the ProSe capability enabled/disabled state indication information may be subdivided according to the various granularities (i.e., the ProSe capability information and the ProSe capability enabled/disabled state indication information are mapped 1-to-1). Alternatively, the ProSe capability information may be subdivided according to the various granularities and the ProSe capability enabled/disabled state indication information may be configured as a single piece of for each UE (i.e., a plurality of subdivided ProSe capabilities may be simultaneously enabled or disabled).

The UE-ProSe capability related information may further include multi-hop communication related information. The multi-hop communication related information may include information indicating whether the UE is capable of performing direct communication in a multi-hop manner with other UEs, and information indicating enabled/disabled state thereof. In addition, the multi-hop communication related information may be subdivided into one or more of information indicating whether the UE is capable of participating in multi-hop communication, information indicating whether the UE is capable of serving as an end node on a multi-hop path, and information indicating whether the UE is capable of serving as a relay node on a multi-hop path.

The UE-ProSe capability related information may further include 1-to-N communication related information. The 1-to-N communication related information may include information indicating whether the UE is capable of performing direct communication with other UEs in a 1-to-N manner, and information indicating enabled/disabled state thereof. In addition, the 1-to-N communication related information may be subdivided into one or more of information indicating whether the UE is capable of participating in 1-to-N communication, information indicating whether the UE is capable of serving as “1” (e.g., master, broadcaster, leader or initiator) in 1-to-N communication, and information indicating whether the UE is capable of serving as “N” (e.g., one of N UEs) in 1-to-N communication.

### Embodiment 2

Embodiment 2 relates to a scheme for determining ProSe availability of a UE and providing related control by a network.

When a network (e.g., control node such as MME) receives UE-ProSe capability related information (see Embodiment 1) from a UE, the network should check predetermined reference information to determine ProSe availability of the UE. The predetermined reference information may be, for example, subscriber information of the UE. Although the subscriber information is generally stored in HSS, if a separate server for ProSe is present, the subscriber information may correspond to information previously configured in a third network node (e.g., ProSe server) or MME. Based on information about permissibility of a rate system, service, etc. subscribed by the UE, which is included in the subscriber information, the network control node (e.g., MME) may analyze/evaluate/determine whether the UE is capable of receiving ProSe. When the network determines, information about capability of the network (e.g., information about whether the network is capable of providing ProSe) may be considered in addition to the UE-ProSe capability related information.

Such ProSe related subscriber information may explicitly or implicitly include capability information and/or capability enabled/disabled state indication information, for example, the multi-hop communication related information and the 1-to-N communication related information mentioned above in Embodiment 1. For example, the subscriber information may include information for identifying subscribers related to a specific multi-hop communication service or 1-to-N service, for example, CSG information of the prior art. The subscriber information may also include subdivided information about whether the UE is capable of participating in multi-hop communication or 1-to-N communication, whether the UE is capable of performing a specific role, etc. as mentioned above in Embodiment 1.

As described above, the network may acquire a part of or the whole UE-ProSe capability related information of a specific UE from the UE or based on the subscriber information.

In addition, the subscriber information may reflect the policy of an operator. For example, the subscriber information may include information evaluated or processed according to the intention of the operator, as well as direct information about service subscription. For a roaming UE, information about ProSe availability of the UE, which is configured in the form of direct or implicit information according to the policy of the operator (e.g., home operator or local operator) may be included in the subscriber information.

Operator policy information may be stored/updated separately from the subscriber information. The operator policy information may be stored in HSS, MME or a third node (e.g., ProSe server). The operator policy information may be used by the network (e.g., control node such as MME) to analyze/evaluate/determine whether the UE is capable of receiving ProSe. The operator policy information may also be defined with and applied to the various granularities described above in Embodiment 1.

The analysis/evaluation/determination result (e.g., information about the ProSe availability of the UE) of the network (e.g., control node such as MME) based on one or more of the UE-ProSe capability related information, the subscriber information and the operator policy information may be stored in a specific node (e.g., HSS, MME and/or a third network node) of the network. In addition, one or more of the UE-ProSe capability related information received from the UE, the ProSe related subscriber information and the ProSe related operator policy information may be stored in a specific node (e.g., HSS, MME and/or a third network node) of the network.

### Embodiment 3

Embodiment 3 relates to a scheme for providing ProSe related information of a network and information about ProSe availability of a UE to the UE by the network.

As described above in Embodiment 2, information about an analysis/evaluation/determination result (e.g., information about ProSe availability of a UE) of a network (e.g., control node such as MME) may be provided to the UE.

Hereinafter, information provided by the network to the UE in relation to ProSe may be referred to as “ProSe related network providing information”. The ProSe related network providing information may include one or more of information about ProSe permissibility of the UE, information about whether the network provides ProSe, information indicating to enable a ProSe capability of the UE and related information thereof, indication information to disable a ProSe capability of the UE and related information thereof, ProSe related operator policy information, ProSe related information for a roaming UE, information about conditions for performing of ProSe by the UE, indication information about operations involved with performing of ProSe by the UE, etc. A detailed description is now given of examples of the information about the determination result of the network.

The ProSe related network providing information may include information about whether the UE is capable of using ProSe (i.e., information about ProSe permissibility of the UE by the network). In addition to information indicating whether the UE is capable of using ProSe, detailed information thereof may be transmitted. For example, multi-hop communication related information may be included in addition to information indicating that the UE is capable of using ProSe. The multi-hop communication related information may be subdivided into one or more of information indicating whether the UE is capable of participating in multi-hop communication, information indicating whether the UE is capable of serving as an end node on a multi-hop path, and information indicating whether the UE is capable of serving as a relay node on a multi-hop path. In addition, 1-to-N communication related information may be further included in addition to information indicating that the UE is capable of using ProSe. The 1-to-N communication related information may be subdivided into one or more of information indicating whether the UE is capable of participating in 1-to-N communication, information indicating whether the UE is capable of serving as “1” (e.g., master, broadcaster, leader or initiator) in 1-to-N communication, and information indicating whether the UE is capable of serving as “N” (e.g., one of N UEs) in 1-to-N communication.

The ProSe related network providing information may include information indicating whether the network is capable of providing ProSe. The information indicating whether the network is capable of providing ProSe may mean a capability/function required by the network to discover UEs in proximity (or to help a UE to discover another UE in its proximity) and/or a capability/function required by the network to make a UE perform direct communication (or to help direct communication between UEs). The capability/function may mean physical capability, functional capability, or both. That is, the capability/function may mean whether actual hardware (H/W) or software (S/W) for implementing the capability/function is present, a fact that ProSe is usable, or the intention to support ProSe.

The ProSe related network providing information may include information indicating to enable ProSe function of the UE and/or related information thereof. The information indicating to enable the ProSe function of the UE may include information to request or indicate to enable a ProSe capability of the UE if the ProSe capability is disabled. The related information may include information for notifying the UE that ProSe is usable (or permitted to be used) while indicating to enable ProSe. The network may indicate to enable the ProSe function of the UE as described above if one or more of the following conditions are satisfied. However, these conditions are merely exemplary and the scope of the present invention is not limited thereto.

A first exemplary condition may be configured as the case in which a RAN is in bad load state or congested. In this case, an operator/network may utilize ProSe for offloading. A second exemplary condition may be configured as the case in which a core network is in bad load state or congested. In this case, the operator/network may utilize ProSe for offloading. Here, whether the RAN/core network is in bad load state or congested may be determined based on a predetermined reference value. Information related to overload or congestion of the RAN may be maintained by a control node of the core network, e.g., MME, acquired from a RAN node, e.g., eNodeB, or acquired from another network node. In addition, information related to overload or congestion of the core network may be maintained by a control node of the core network, e.g., MME, or acquired from another network node. A third exemplary condition may be configured as the case in which the UE is camped on a specific location (e.g., cell, eNodeB, Tracking Area (TA), etc.). For example, the specific location may be configured as a place of frequent accidents, e.g., seashore or mountain. In this case, the operator may utilize ProSe for public safety. A fourth exemplary condition may be configured as the case in which the UE belongs to a specific contact list or group. For example, if a user has specific membership (e.g., Starbucks membership), ProSe may be utilized to promote communication between members for commercial or social networking.

The ProSe related network providing information may include indication information to disable ProSe function of the UE and/or related information thereof. The indication information to disable the ProSe function of the UE may include information to request or indicate to disable a ProSe capability of the UE if the ProSe capability is enabled. The related information may include information indicating a cause or reason to disable the ProSe capability. The network may indicate to disable the ProSe function of the UE as described above if one or more of the following conditions are satisfied. However, these conditions are merely exemplary and the scope of the present invention is not limited thereto.

A first exemplary condition may be configured as the case in which a RAN is in good load state or not congested. A second exemplary condition may be configured as the case in which a core network is in good load state or not congested. A third exemplary condition may be configured as the case in which the UE is camped on a location other than a specific location (e.g., cell, eNodeB, TA, etc.). For example, this case may correspond to the case in which a user is out of a place of frequent accidents. A fourth exemplary condition may be configured as the case in which the UE belongs to a specific contact list or group. For example, if a user has specific membership (e.g., Starbucks membership), the network may temporarily stop ProSe enabled according to previously configured information for commercial or social networking.

The ProSe related network providing information may include information about operator policy. The operator policy may include home operator policy and/or local operator policy. The granularity of the operator policy may be variously configured as, for example, a media/content type, an APN, a QCI, a bearer/connection type, an application type, a service type, a destination domain, an opposite UE, a CSG, etc. The various granularities for the operator policy are merely exemplary, and the scope of the present invention is not limited thereto. In addition, the UE may be determined whether to use subdivided ProSe for each granularity, or determined whether to use ProSe for a combination of two or more of the granularities. That is, information about whether ProSe is usable, etc. may be transmitted to the UE based on the operator policy defined with the above-mentioned granularities. The operator policy may be stored/updated in HSS, a control node such as MME/SGSN, or a third node separately from subscriber information.

The ProSe related network providing information may include information about roaming agreements for a roaming UE. For example, when the UE is current roaming, information about whether ProSe is usable in (or receivable from) a network to which the roaming UE is currently connected may be included in this type of information.

The ProSe related network providing information may include information about conditions for performing of ProSe by the UE. The conditions for performing of ProSe by the UE may overlap with those previously configured in the UE, or the UE may include information about conditions to be added to the previously configured conditions.

The ProSe related network providing information may include information indicting operations to be performed together when the UE performs ProSe. For example, when the UE performs a ProSe operation, information indicating to report predetermined feedback information about ProSe initiation/termination/result, etc. or state information about a changed state of the UE to the network may be included in this type of information.

If the UE has two or more ProSe capabilities, the ProSe related network providing information (e.g., the ProSe related information of the network and the information about the ProSe availability of the UE) may be provided equally or individually with respect to the capabilities.

The ProSe related network providing information may be transmitted from the network to the UE using one or more of methods described below.

According to a first method, the ProSe related network providing information described above in Embodiment 3 may be included in a response message (e.g., attach accept, TAU accept, RAU accept or ProSe Discovery response message) to a message (e.g., attach request, TAU request, RAU request message or ProSe Discovery request message) used to transmit the UE-ProSe capability related information from the UE to the network in Embodiment 1. Alternatively, the ProSe related network providing information described above in Embodiment 3 may be included in a response message to a newly defined message used to transmit the UE-ProSe capability related information from the UE to the network in Embodiment 1. Here, even when the UE-ProSe capability related information is not included in a message transmitted from the UE to the network, a response message including the ProSe related network providing information may be provided from the network to the UE. A network node for transmitting the response message may be a control node such as MME or SGSN.

According to a second method, the ProSe related network providing information may be transmitted from HSS, ANDSF or a third network node (e.g., server for or in charge of ProSe) to the UE using an Open Mobile Alliance-Device Management (OMA DM) scheme, an Over The Air (OTA) scheme, or a message newly defined for the present invention. In this case, the ProSe related network providing information may be transmitted to the UE as a response to the message received from the UE, by self determination of the network node, or upon a request from another node.

### Embodiment 4

Embodiment 4 relates to a scheme for analyzing/evaluating/determining ProSe availability of a UE.

ProSe availability of the UE may be analyzed/evaluated/determined based on one or more of UE-ProSe capability related information, ProSe related network providing information, and information previously configured in the UE.

The UE-ProSe capability related information may include information about a ProSe capability of the UE and information indicating enabled/disabled state of the ProSe capability as described above in Embodiment 1. The ProSe availability of the UE may be determined based on the UE-ProSe capability related information as described below.

If the UE has two or more ProSe capabilities, information about a part or all of the capabilities may be used to determine the ProSe availability of the UE. Here, the ProSe capability of the UE may mean a capability/function required by the UE to discover another UE in its proximity (or to be helped by a network to discover another UE in its proximity) and/or a capability/function required by the UE to perform direct communication. The capability/function may mean physical capability, functional capability, or both. That is, the capability/function may mean whether actual H/W or S/W for implementing the capability/function is present, a fact that ProSe is usable, or the intention to support ProSe. In particular, if the UE-ProSe capability related information does not additionally include information indicating enabled/disabled state of a capability, i.e., if only capability information is present, it may be implicitly indicated that the capability is enabled.

The ProSe related network providing information may include information about policy related to ProSe, whether the network supports ProSe, etc., which is received by the UE from the network, as described above in Embodiment 3.

The information previously configured in the UE may include, for example, UE preference, operator policy (home operator policy and/or local operator policy), conditions for performing of ProSe by the UE, etc.

### Embodiment 5

Embodiment 5 relates to a scheme for reporting a result of determining ProSe availability of a UE to a network.

In Embodiment 4 described above, the UE may analyze/evaluate/determine ProSe availability and report information indicating that the UE is capable of using ProSe and/or information indicating the intention of the UE to use ProSe, to the network as the determination result. The report to the network about the ProSe availability of the UE may be performed immediately after the determination operation of the UE in Embodiment 4, or later.

Information indicating the ProSe availability of the UE may be transmitted to the network using a typically defined control message or a newly defined message. In addition, the information indicating the ProSe availability of the UE may be transmitted to the network together with the UE-ProSe capability related information (i.e., information indicating a ProSe capability of the UE and/or enabled/disabled state of the ProSe capability).

A network node which receives the information indicating the ProSe availability of the UE may include one or more nodes. For example, the one or more nodes may include a mobility management node such as MME or SGSN, an AAA server or an AAA proxy server, a server for ProSe, an ANDSF entity, an eNodeB, a gateway node such as P-GW, etc. The above network node(s) may receive the information indicating the ProSe availability of the UE directly from the UE or via another network node.

### Embodiment 6

Embodiment 6 relates to a scheme for performing a ProSe related operation by a UE.

The ProSe related operation of the UE may correspond to an operation for initiating or terminating ProSe-based application or service.

The ProSe related operation may include an operation for updating enabled/disabled state related to ProSe by the UE. For example, the ProSe related operation may include an operation for automatically switching disabled capability for ProSe to enabled state. In addition, the enabled/disabled state related to ProSe may be updated according to previously configured information, manual configuration of a user, or interaction with the user.

The ProSe related operation may include an operation for performing a discovery procedure for an opposite UE for ProSe. Here, the discovery procedure may mean that the UE performs the discovery procedure or requests the discovery procedure to the network.

The ProSe related operation may include an operation for transmitting an initial request signal for direct path setup to the network or the opposite UE. The direct path setup may be performed the opposite UE is detected/discovered in the discovery procedure.

The ProSe related operation may include an operation for releasing a connected direct path.

The ProSe related operation may include an operation for updating ProSe related information in the UE.

The ProSe related operation may include an operation for performing indications of the network in Embodiment 3 (e.g., indication to enable a ProSe capability of the UE, indication to disable the ProSe capability of the UE, and operations involved with a ProSe operation (e.g., indication to report predetermined feedback information about ProSe initiation/termination/result, etc., indication to report state information about a changed state of the UE, etc.)).

ProSe of the UE may be supported or controlled according to the operation mechanisms of the UE and the network described above in Embodiments 1 to 6.

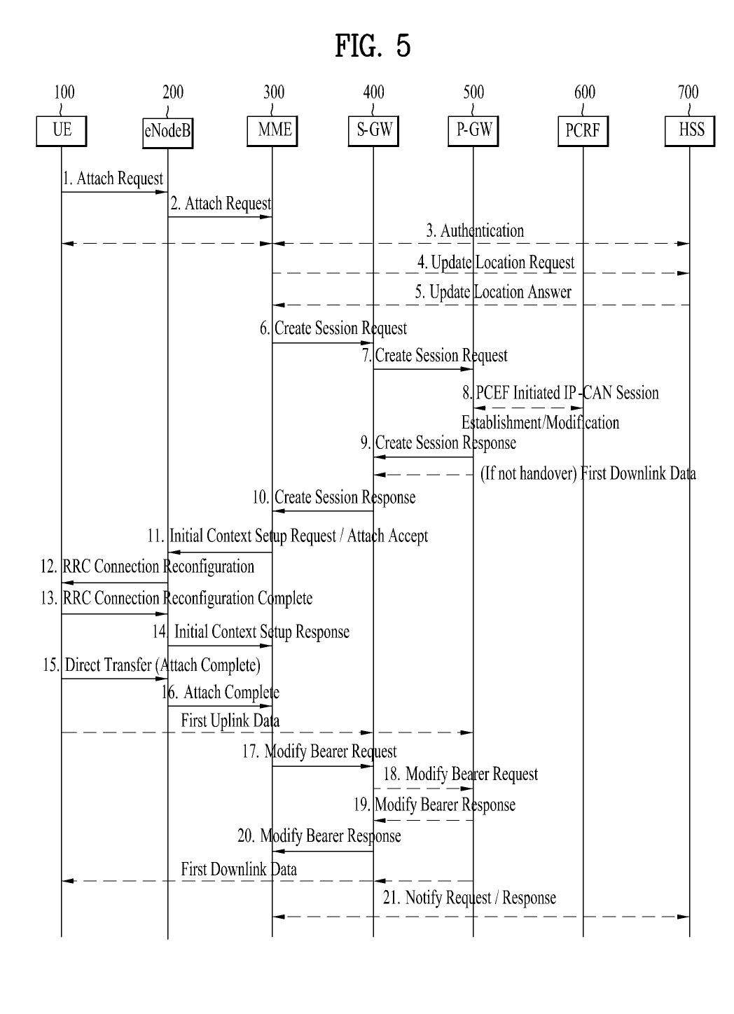

FIG. 5 is a flowchart for describing ProSe related control signaling according to an embodiment of the present invention. Although ProSe related control signaling is described using an attach procedure as an example in FIG. 5, the principle of the present invention is equally applicable to a TAU procedure, an RAU procedure, etc.

In steps 1 and 2 of FIG. 5, a UE 100 may transmit an attach request via an eNodeB 200 to an MME 300. In this case, UE-ProSe capability related information may be included in an attach request message (see Embodiment 1).

The MME 300 which has received the UE-ProSe capability related information from the UE 100 may store the received information as it is and/or in a processed format.

Information indicating enabled/disabled state of a specific capability, which is included in the UE-ProSe capability related information, may be configured according to interaction with a user. Alternatively, the information indicating the enabled/disabled state of the specific capability may be configured according to a predetermined condition without interaction with the user. For example, a corresponding ProSe capability may be enabled if the UE 100 is camped on a HeNB and disabled if the UE 100 is camped on an eNodeB.

In addition, the UE-ProSe capability related information may be added to the attach request message as a new parameter field. Alternatively, the UE-ProSe capability related information may be included using an existing parameter of the attach request message.

Table 2 exemplarily shows information elements included in the attach request message. For details of the attach request message, reference can be made to 3GPP TS 24.301 Clause 8.2.4.

TABLE 2

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Attach request message identity | Message type | M | V | 1 |
| | | 9.8 | | | |
| | EPS attach type | EPS attach type | M | V | ½ |
| | | 9.9.3.11 | | | |
| | NAS key set identifier | NAS key set identifier | M | V | ½ |
| | | 9.9.3.21 | | | |
| | EPS mobile identity | EPS mobile identity | M | LV | 5-12 |
| | | 9.9.3.12 | | | |
| | UE network capability | UE network capability | M | LV | 3-14 |
| | | 9.9.3.34 | | | |
| | ESM message container | ESM message container | M | LV-E | 5-n |
| | | 9.9.3.15 | | | |
| 19 | Old P-TMSI signature | P-TMSI signature | O | TV | 4 |
| | | 10.5.5.8 | | | |
| 50 | Additional GUTI | EPS mobile identity | O | TLV | 13 |
| | | 9.9.3.12 | | | |
| 52 | Last visited registered TAI | Tracking area identity | O | TV | 6 |
| | | 9.9.3.32 | | | |
| 5C | DRX parameter | DRX parameter | O | TV | 3 |
| | | 9.9.3.8 | | | |
| 31 | MS network capability | MS network capability | O | TLV | 4-10 |
| | | 9.9.3.20 | | | |
| 13 | Old location area identification | Location area identification | O | TV | 6 |
| | | 9.9.2.2 | | | |
| 9- | TMSI status | TMSI status | O | TV | 1 |
| | | 9.9.3.31 | | | |
| 11 | Mobile station classmark 2 | Mobile station classmark 2 | O | TLV | 5 |
| | | 9.9.2.4 | | | |
| 20 | Mobile station classmark 3 | Mobile station classmark 3 | O | TLV | 2-34 |
| | | 9.9.2.5 | | | |
| 40 | Supported Codecs | Supported Codec List | O | TLV | 5-n |
| | | 9.9.2.10 | | | |
| F- | Additional update type | Additional update type | O | TV | 1 |
| | | 9.9.3.0B | | | |
| 5D | Voice domain preference and | Voice domain preference and UE's | O | TLV | 3 |
| | UE's usage setting | usage setting | | | |
| | | 9.9.3.44 | | | |
| D- | Device properties | Device properties | O | TV | 1 |
| | | 9.9.2.0A | | | |
| E- | Old GUTI type | GUTI type | O | TV | 1 |
| | | 9.9.3.45 | | | |

The UE-ProSe capability related information may be included using one or more of the information elements shown in Table 2, or as a new information element not shown in Table 2. For example, the UE-ProSe capability related information may be transmitted to the MME 300 using an information element such as UE network capability or MS network capability in Table 2.

The UE network capability information element in Table 2 is defined to provide information about aspects of UEs related to a core network to a network. In addition, the MS network capability information element may be included to indicate capabilities of a Mobile Station (MS) to the network by the MS. Accordingly, the UE network capability or MS network capability information element among the information elements included in the attach request message may be appropriately used to transmit the UE-ProSe capability related information proposed by the present invention to the network.

In steps 3 and 4 of FIG. 5, the MME 300 may perform authentication on the UE 100 and register location information, etc. of the UE 100 in a HSS 700. For example, in step 4, the MME 300 may include information received from the UE 100 (e.g., UE-ProSe capability related information) in an Update Location Request (ULR) message and transmit the message to the HSS 700. In addition, the UE-ProSe capability related information may be included in a message exchanged between the MME 300 and the HSS 700 during the authentication of step 3, as well as the ULR message of step 4. As such, the UE-ProSe capability related information may be stored in the MME 300 and the HSS 700. If the UE-ProSe capability related information is stored in a third node, another control signal or message may be used.

In particular, the information received from the UE 100 may be transmitted to the HSS 700 directly without being processed by the MME 300, or after being processed as a mixture of various types of information. If the MME 300 has already analyzed/evaluated/determined ProSe availability of the UE 100, a result value only or together with the UE-ProSe capability related information may be transmitted to the HSS 700.

Specifically, the analysis/evaluation/determination of the ProSe availability of the UE 100 by the MME 300 may be performed before or after step 4. The reason why the determination of the MME 300 can be performed before step 4 is because the MME 300 may have information about the UE 100, e.g., subscriber information, network capability, etc., due to another procedure or method before step 4, and the ProSe availability, etc. of the UE 100 may be determined in consideration of the above information together with the UE-ProSe capability related information.

Additionally, the information received from the UE 100 (e.g., the UE-ProSe capability related information) may be processed in consideration of network capability known or determinable by the MME 300. For example, if the UE 100 can support ProSe but the network does not support ProSe, UE information and/or network information may be transmitted together to the HSS 700, or information about a result value processed by the MME 300 may be transmitted to the HSS 700.

The ProSe related information transmitted from the MME 300 to the HSS 700 may mean to explicitly or implicitly request the HSS 700 to transmit ProSe related subscriber information associated with a subscriber to which the UE 100 belongs, to the MME 300. As such, the HSS 700 may transmit subscriber information (more particularly, ProSe related subscriber information) of the UE 100 to the MME 300 (step 5 of FIG. 5).

The MME 300 includes the UE-ProSe capability related information or processed information thereof in the ULR message and transmits the ULR message to the HSS 700 in step 4 described above. Table 3 exemplarily shows the information included in the ULR message. The UE-ProSe capability related information or the processed information thereof, which is transmitted from the MME 300 to the HSS 700, may be included in a format similar to a UE-SRVCC-Capability parameter field among information elements shown in Table 3, or as a new parameter field. For details of the ULR message, reference can be made to 3GPP TS 29.272 Clause 7.2.3.

TABLE 3
Message Format

< Update-Location-Request> ::= < Diameter Header: 316, REQ,
PXY, 16777251 >

< Session-Id >
[ Vendor-Specific-Application-Id ]
{ Auth-Session-State }
{ Origin-Host }
{ Origin-Realm }
[ Destination-Host ]
{ Destination-Realm }
{ User-Name }
*[ Supported-Features ]
[ Terminal-Information ]
{ RAT-Type }
{ ULR-Flags }
[UE-SRVCC-Capability ]
{ Visited-PLMN-Id }
[ SGSN-Number ]
[ Homogeneous-Support-of-IMS-Voice-Over-PS-Sessions ]
[ GMLC-Address ]
*[ Active-APN ]
*[ AVP ]
*[ Proxy-Info ]
*[ Route-Record ]

In Table 3, the UE-SRVCC-Capability information element may indicate whether the UE 100 supports or does not support Single Radio Voice Call Continuity (SRVCC) capability. Similarly, an information element having information indicating whether the UE 100 supports or does not support a ProSe capability may be included in the ULR message.

The UE-ProSe capability related information or the processed information thereof, which is transmitted from the MME 300 to the HSS 700, may be stored as HSS data together with other types of information to be stored in the HSS 700. Table 4 exemplarily shows fields included in the HSS data. For details of the HSS data, reference can be made to 3GPP TS 23.401 Clause 5.7.1.

TABLE 4

| Field | Description |
|---|---|
| IMSI | IMSI is the main reference key. |
| MSISDN | The basic MSISDN of the UE (Presence of MSISDN is optional). |
| IMEI/IMEISV | International Mobile Equipment Identity - Software Version Number |
| MME Identity | The Identity of the MME currently serving this MS. |
| MME Capabilities | Indicates the capabilities of the MME with respect to core functionality e.g. |
| | regional access restrictions. |
| MS PS Purged from EPS | Indicates that the EMM and ESM contexts of the UE are deleted from the |
| | MME. |
| ODB parameters | Indicates that the status of the operator determined barring |
| Access Restriction | Indicates the access restriction subscription information. |
| EPS Subscribed Charging | The charging characteristics for the MS, e.g. normal, prepaid, flat-rate, |
| Characteristics | and/or hot billing subscription. |
| Trace Reference | Identifies a record or a collection of records for a particular trace. |
| Trace Type | Indicates the type of trace, e.g. HSS trace, and/or MME/Serving GW/PDN |
| | GW trace. |
| OMC Identity | Identifies the OMC that shall receive the trace record(s). |
| Subscribed-UE-AMBR | The Maximum Aggregated uplink and downlink MBRs to be shared across |
| | all Non-GBR bearers according to the subscription of the user. |
| APN-OI Replacement | Indicates the domain name to replace the APN OI when constructing the |
| | PDN GW FQDN upon which to perform a DNS resolution. This replacement |
| | applies for all the APNs in the subscriber's profile. See TS 23.003 [9] |
| | clause 9.1.2 for more information on the format of domain names that are |
| | allowed in this field. |
| RFSP Index | An index to specific RRM configuration in the E-UTRAN |
| URRP-MME | UE Reachability Request Parameter indicating that UE activity notification |
| | from MME has been requested by the HSS. |
| CSG Subscription Data | The CSG Subscription Data is a list of CSG IDs per PLMN and for each |
| | CSG ID optionally an associated expiration date which indicates the point in |
| | time when the subscription to the CSG ID expires; an absent expiration date |
| | indicates unlimited subscription. |
| | For a CSG ID that can be used to access specific PDNs via Local IP |
| | Access, the CSG ID entry includes the corresponding APN(s). |
| VPLMN LIPA Allowed | Specifies per PLMN whether the UE is allowed to use LIPA. |
| Subscribed Periodic RAU/TAU | Indicates a subscribed Periodic RAU/TAU Timer value |
| Timer | |
| MPS CS priority | Indicates that the UE is subscribed to the eMLPP or 1x RTT priority service |
| | in the CS domain. |
| UE-SRVCC- Capability | Indicates whether the UE is UTRAN/GERAN SRVCC capable or not. |
| MPS EPS priority | Indicates that the UE is subscribed to MPS in the EPS domain. |

Each subscription profile contains one or more PDN subscription contexts:

| | |
|---|---|
| Context Identifier | Index of the PDN subscription context. |
| PDN Address | Indicates subscribed IP address(es). |
| PDN Type | Indicates the subscribed PDN Type (IPv4, IPv6, IPv4v6) |
| APN-OI Replacement | APN level APN-OI Replacement which has same role as UE level APN-OI |
| | Replacement but with higher priority than UE level APN-OI Replacement. |
| | This is an optional parameter. When available, it shall be used to construct |
| | the PDN GW FQDN instead of UE level APN-OI Replacement. |
| Access Point Name (APN) | A label according to DNS naming conventions describing the access point |
| | to the packet data network (or a wildcard) (NOTE 6). |
| SIPTO permissions | Indicates whether the traffic associated with this APN is allowed or |
| | prohibited for SIPTO |
| LIPA permissions | Indicates whether the PDN can be accessed via Local IP Access. Possible |
| | values are: LIPA-prohibited, LIPA-only and LIPA-conditional. |
| EPS subscribed QoS profile | The bearer level QoS parameter values for that APN's default bearer (QCI |
| | and ARP) (see clause 4.7.3). |
| Subscribed-APN-AMBR | The maximum aggregated uplink and downlink MBRs to be shared across |
| | all Non-GBR bearers, which are established for this APN. |
| EPS PDN Subscribed Charging | The charging characteristics of this PDN Subscribed context for the MS, |
| Characteristics | e.g. normal, prepaid, flat-rate, and/or hot billing subscription. The charging |
| | characteristics is associated with this APN. |
| VPLMN Address Allowed | Specifies per VPLMN whether for this APN the UE is allowed to use the |
| | PDN GW in the domain of the HPLMN only, or additionally the PDN GW in |
| | the domain of the VPLMN. |
| PDN GW identity | The identity of the PDN GW used for this APN. The PDN GW identity may |
| | be either an FQDN or an IP address. The PDN GW identity refers to a |
| | specific PDN GW. |
| PDN GW Allocation Type | Indicates whether the PDN GW is statically allocated or dynamically |
| | selected by other nodes. A statically allocated PDN GW is not changed |
| | during PDN GW selection. |
| PLMN of PDN GW | Identifies the PLMN in which the dynamically selected PDN GW is located. |
| Homogenous Support of IMS | Indicates whether or not “IMS Voice over PS Sessions” is supported |
| Over PS Sessions for MME | homogeneously in all TAs in the serving MME. |

List of APN - PDN GW ID relations (for PDN subscription context with wildcard APN):

| | |
|---|---|
| APN - P-GW relation #n | The APN and the identity of the dynamically allocated PDN GW of a PDN |
| | connection that is authorised by the PDN subscription context with the |
| | wildcard APN. The PDN GW identity may be either an FQDN or an IP |
| | address. The PDN GW identity refers to a specific PDN GW. |

If a new field is added to store the UE-ProSe capability related information or the processed information thereof as the HSS data, this may be configured in a format similar to a UE-SRVCC-Capability field in Table 4. For example, information indicating whether the UE 100 supports or does not support a ProSe capability may be included in or stored as the HSS data. In addition, the UE-ProSe capability related information or the processed information thereof (e.g., information indicating whether the UE 100 supports or does not support one or more ProSe capabilities and/or information indicating enabled/disabled state of individual ProSe capabilities) may be included in or stored as the HSS data in a format similar to an MME Capabilities field of the HSS data in Table 4.

In step 5 of FIG. 5, the HSS 700 may transmit an update location answer message including subscriber information of a subscriber to which the UE 100 belongs, to the MME 300. Although the subscriber information of the UE 100 is generally stored in the HSS 700, if a third node for ProSe (e.g., ProSe server) is present, the MME 300 may acquire ProSe related subscriber information from the third node, or determine ProSe related subscriber information of the UE 100 based on information previously configured in the MME 300.

After that, the MME 300 may check the subscriber information of the UE 100 acquired in step 5 together with the UE-ProSe capability related information acquired in steps 1 and 2. For example, the MME 300 may check permission information about a rate system, service, etc. subscribed by the UE 100, and then analyze/evaluate/determine whether the UE 100 is capable of receiving ProSe. When the MME 300 determines, network capability information, e.g., information about whether the network is capable of providing ProSe, and the policy of an operator may be considered (see Embodiment 2).

It is assumed that the MME 300 acquires the subscriber information (more particularly, the ProSe related subscriber information) of the UE 100 from the HSS 700 as in step 5 of FIG. 5. In this case, the HSS 700 may additionally define a new field for subscriber data or store the ProSe related information using an existing field, and transmit the corresponding information to the MME 300.

Table 5 exemplarily shows fields for subscription data. For details of the subscription data, reference can be made to 3GPP TS 29.272 Clause 7.3.2.

TABLE 5

AVP format:

Subscription-Data ::= <AVP header: 1400 10415>

[ Subscriber-Status ]
[ MSISDN ]
[ STN-SR ]
[ ICS-Indicator ]
[ Network-Access-Mode ]
[ Operator-Determined-Barring ]
[ HPLMN-ODB ]
*10[ Regional-Subscription-Zone-Code]
[ Access-Restriction-Data ]
[ APN-OI-Replacement ]
[ LCS-Info ]
[ Teleservice-List ]
[ Call-Barring-Infor-List ]
[ 3GPP-Charging-Characteristics ]
[ AMBR ]
[ APN-Configuration-Profile ]
[ RAT-Frequency-Selection-Priority-ID ]
[ Trace-Data]
[ GPRS-Subscription-Data ]
*[ CSG-Subscription-Data ]
[ Proximity Service-Subscription-Data ]
[ Roaming-Restricted-Due-To-Unsupported-Feature ]
[ Subscribed-Periodic-RAU-TAU-Timer ]
[ MPS-Priority ]
[ VPLMN-LIPA-Allowed ]
[ Relay-Node-Indicator ]
[ MDT-User-Consent ]
[Subscribed-VSRVCC ]
*[ AVP ]

Table 5 exemplarily shows [Proximity Service-Subscription-Data] as a new field not included for the existing subscription data. This [Proximity Service-Subscription-Data] field may include the above-described ProSe related subscriber information.

The analysis/evaluation/determination result of the MME 300 may be stored in the HSS 700, the MME 300 and/or a third network node. In this case, if the information received from the UE 100 in the previous step (e.g., the UE-ProSe capability related information or the processed information thereof) is not yet stored in the HSS 700, the received information may be stored together with the determination result value of the MME 300.

If the determination result value of the MME 300 is stored in the HSS 700, mutual operations between the MME 300 and the HSS 700 like those in steps 3 and 4 of FIG. 5 may be used. If the determination result value of the MME 300 is stored is stored in a third network node, another new control signal or message may be used. If the determination result value of the MME 300 is stored in the MME 300, a typical scheme for storing it in MME context may be used.

In steps 6 to 10 of FIG. 5 (step 8 will be described separately), the MME 300 may transmit a create session request message to an S-GW 400 and the S-GW 400 may transmit the create session request message to the P-GW 500.

In response to the create session request message, the P-GW 500 may transmit a create session response message to the S-GW 400 and the S-GW 400 may transmit the create session response message the MME 300.

Step 8 of FIG. 5 corresponds to an optional procedure, and a Policy and Charging Rules Function (PCRF) operation for operator policy may be exchanged between a Policy and Charging Enforcement Function (PCEF) of the P-GW 500 and a PCRF 600 as necessary. For example, IP-Connectivity Access Network (CAN) session for providing IP connectivity may be established and/or modified. IP-CAN refers to various IP-based access networks, for example, a 3GPP access network such as GPRS, EDGE, etc., a wireless local area network (WLAN), or a digital subscriber line (DSL) network.

In step 11 of FIG. 5, an attach accept message may be transmitted from the MME 300 to the eNodeB 200. In step 12, a Radio Resource Control (RRC) connection reconfiguration message may be transmitted from the eNodeB 200 to the UE 100.

In steps 11 and 12, when the MME 300 transmits a control message to the UE 100, ProSe related network providing information (e.g., information about ProSe related network capability, information indicating whether a corresponding service is usable, etc.) may be transmitted. In this case, the analysis/evaluation/determination result of the MME 300 about the ProSe availability of the UE 100 or information simply indicating whether the network supports ProSe may be transmitted (see Embodiment 3).

If the attach accept message is used to transmit the ProSe related network providing information (step 11), the ProSe related network providing information may be transmitted by adding a new parameter field to the attach accept message or using an existing parameter (e.g., EPS network feature support).

Table 6 exemplarily shows information elements included in the attach accept message. For details of the attach accept message, reference can be made to 3GPP TS 24.301 Clause 8.2.1.

TABLE 6

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Attach accept message identity | Message type | M | V | 1 |
| | | 9.8 | | | |
| | EPS attach result | EPS attach result | M | V | ½ |
| | | 9.9.3.10 | | | |
| | Spare half octet | Spare half octet | M | V | ½ |
| | | 9.9.2.9 | | | |
| | T3412 value | GPRS timer | M | V | 1 |
| | | 9.9.3.16 | | | |
| | TAI list | Tracking area identity list | M | LV | 7-97 |
| | | 9.9.3.33 | | | |
| | ESM message container | ESM message container | M | LV-E | 5-n |
| | | 9.9.3.15 | | | |
| 50 | GUTI | EPS mobile identity | O | TLV | 13 |
| | | 9.9.3.12 | | | |
| 13 | Location area identification | Location area identification | O | TV | 6 |
| | | 9.9.2.2 | | | |
| 23 | MS identity | Mobile identity | O | TLV | 7-10 |
| | | 9.9.2.3 | | | |
| 53 | EMM cause | EMM cause | O | TV | 2 |
| | | 9.9.3.9 | | | |
| 17 | T3402 value | GPRS timer | O | TV | 2 |
| | | 9.9.3.16 | | | |
| 59 | T3423 value | GPRS timer | O | TV | 2 |
| | | 9.9.3.16 | | | |
| 4A | Equivalent PLMNs | PLMN list | O | TLV | 5-47 |
| | | 9.9.2.8 | | | |
| 34 | Emergency number list | Emergency number list | O | TLV | 5-50 |
| | | 9.9.3.37 | | | |
| 64 | EPS network feature support | EPS network feature support | O | TLV | 3 |
| | | 9.9.3.12A | | | |
| F- | Additional update result | Additional update result | O | TV | 1 |
| | | 9.9.3.0A | | | |
| 5E | T3412 extended value | GPRS timer 3 | O | TLV | 3 |
| | | 9.9.3.16B | | | |

The EPS network feature support information element in Table 6 is defined to indicate whether features are supported by the network. Accordingly, the EPS network feature support information element among the information elements included in the attach accept message may be appropriately used to transmit the ProSe related network providing information proposed by the present invention via the eNodeB 200 to the UE 100.

In step 13 of FIG. 5, the UE 100 may transmit an RRC connection reconfiguration complete message to the eNodeB 200. As such, in step 14, the eNodeB 200 may transmit an initial context setup response message to the MME 300.

Meanwhile, in step 12 of FIG. 5, the UE 100 which has received the ProSe related network providing information (e.g., information about ProSe related operator policy, whether the network supports ProSe, etc.) may analyze/evaluate/determine whether ProSe is usable in overall consideration of the UE-ProSe capability related information of the UE 100 (see Embodiment 4)

Based on the determination result about the ProSe availability of the UE 100, the UE 100 may report information indicating the ProSe availability and/or information indicating the intention to use ProSe to the network. In this regard, an attach complete message of steps 15 and 16 of FIG. 5 may be used (see Embodiment 5).

If the UE 100 indicates to use ProSe to the network, ProSe between the UE 100 and another UE (not shown) may be initiated. For example, the UE 100 may detect/discover another UE in its proximity, sets up a ProSe communication path as described above in relation to FIG. 3 or 4, and perform ProSe communication with the other UE (see Embodiment 6).

Meanwhile, if the UE 100 does not have a ProSe capability, if the ProSe capability is disabled, if the network does not support ProSe, etc., the UE 100 may set up a data path with the other UE according to a typical scheme (e.g., infrastructure communication scheme illustrated in FIG. 2) without using ProSe.

Step 21 corresponds to an optional procedure. If IDs, etc. of APN and PDN GW need to be stored in the HSS 700 to support mobility to a non-3GPP access network as necessary, the MME 300 may perform HSS registration using a notify request message, and receive a notify response message from the HSS 700.

The above-described embodiments of the present invention may be applied independently or two or more embodiments may be applied simultaneously.

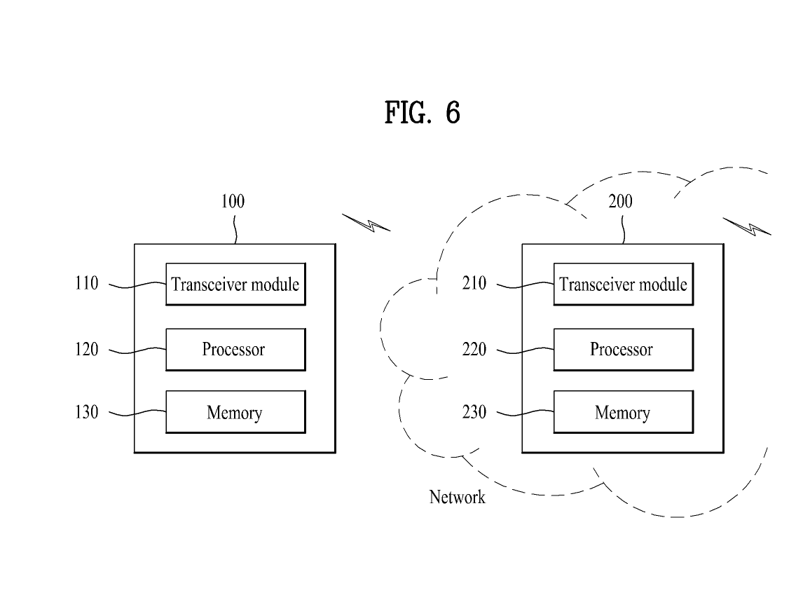

FIG. 6 is a view illustrating the configurations of a UE 100 and a network node 200 according to an embodiment of the present invention.

Referring to FIG. 6, the UE 100 may include a transceiver module 110, a processor 120 and a memory 130. The transceiver module 110 may be configured to transmit and receive various types of signal, data and information to and from an external device. The UE 100 may be connected to the external device by wire and/or wirelessly. The processor 120 may be configured to provide overall control to the UE 100 and process information, etc. to be transmitted to or received from the external device by the UE 100. The memory 130 may store the processed information, etc. for a predetermined time and replaced by an element such as a buffer (not shown).

The UE 100 may be configured for ProSe. The processor 120 may be configured to transmit ProSe capability related information of the UE 100 to the network node 200 using the transceiver module 110. The processor 120 may be configured to receive ProSe related network providing information from the network node 200 using the transceiver module 110. The processor 120 may be configured to determine ProSe availability of the UE 100 based on one or more of the ProSe capability related information of the UE 100 and the received ProSe related network providing information. The processor 120 may be configured to transmit the determination result about the ProSe availability of the UE 100 to the network node 200 using the transceiver module 110.

Referring to FIG. 6, the network node 200 may include a transceiver module 210, a processor 220 and a memory 230. The transceiver module 210 may be configured to transmit and receive various types of signal, data and information to and from an external device. The network node 200 may be connected to the external device by wire and/or wirelessly. The processor 220 may be configured to provide overall control to the network node 200 and process information, etc. to be transmitted to or received from the external device by the network node 200. The memory 230 may store the processed information, etc. for a predetermined time and replaced by an element such as a buffer (not shown).

The network node 200 may be configured to support ProSe of the UE 100. The processor 220 may be configured to receive the ProSe capability related information of the UE 100 from the UE 100 using the transceiver module 210. The processor 220 may be configured to determine the ProSe availability of the UE 100 based on one or more of the ProSe capability related information of the UE 100, subscriber information of the UE 100, and operator policy information. The processor 220 may be configured to transmit the determination result to the UE 100 as the ProSe related network providing information using the transceiver module 210. The processor 220 may be configured to receive information about the ProSe availability of the UE 100, which is determined based on one or more of the ProSe capability related information of the UE 100 and the ProSe related network providing information, from the UE 100 using the transceiver module 210.

The network node 200 may be configured to support ProSe between a plurality of UEs. The processor 220 of the network node 200 may be configured to receive ProSe basis information from the UE 100 or another network node using the transceiver module 210. The processor 220 may be configured to transmit ProSe permissibility indication information to the UE 100 using the transceiver module 210. The processor 220 may be configured to process signaling for supporting direct data path setup between the UE 100 and another UE. The processor 220 may be configured to receive ProSe performance result information from the UE 100 using the transceiver module 210.

In addition, for the detailed configurations of the UE 100 and the network node 200, the above-described embodiments of the present invention may be applied independently or two or more embodiments may be applied simultaneously, and repeated descriptions are omitted for clarity.

The above-described embodiments of the present invention may be implemented by various means, for example, hardware, firmware, software, or a combination thereof.

In a hardware configuration, the methods according to embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to embodiments of the present invention may be implemented in the form of a module, a procedure, a function, etc. performing the above-described functions or operations. A software code may be stored in the memory 130 or 230 and executed by the processor 120 or 220. The memory 130 or 230 may be located inside or outside the processor 120 or 220 and exchange data with the processor 120 or 220 via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged.

Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

### INDUSTRIAL APPLICABILITY

The above-described embodiments of the present invention are applicable to various mobile communication systems.

1-12. (canceled)

13. A method for supporting proximity service (ProSe) of a user equipment (UE) by a network node in a wireless communication system, the method comprising:
receiving, by the network node from a base station of the UE, a first message including ProSe capability related information of the UE;
storing, by the network node, the ProSe capability related information; and
transmitting, by the network node to the base station of the UE, a second message including information about ProSe permissibility of the UE.

14-15. (canceled)

16. The method according to claim 13, wherein the ProSe capability related information of the UE comprises one or more of information indicating one or more ProSe capabilities of the UE, and information indicating enabled or disabled state of each of the ProSe capabilities.

17. The method according to claim 13, the ProSe capability related information of the UE comprises at least one of:
a capability of the UE to discover another UE in its proximity,
information indicating whether the UE is capable of performing direct communication with another UE, or
information indicating whether the UE is capable of serving as a relay node.

18. The method according to claim 13, wherein the ProSe capability related information is defined with one or more granularities among a media or content type, an Access Point Name (APN), a QoS (Quality of Service) Class Identifier (QCI), a bearer or connection type, an application type, a service type, a destination domain, an opposite UE for communication, and a Closed Subscriber Group (CSG).

19. The method according to claim 13, wherein the ProSe capability related information of the UE is further stored in one or more of a Home Subscriber Server (HSS) and a ProSe server.

20. The method according to claim 13, wherein the second message further comprises ProSe related network providing information: the ProSe related network providing information comprises one or more of information about whether a network has a ProSe capability, information indicating to enable a ProSe capability of the UE and related information thereof, indication information to disable the ProSe capability of the UE and related information thereof, ProSe related operator policy information, ProSe related information for a roaming UE, information about conditions for performing of ProSe by the UE, and indication information about operations involved with performing of ProSe by the UE.

21. The method according to claim 20, wherein the ProSe related network providing information is determined by at least one of the network node, a Home Subscriber Server (HSS) or a ProSe server, based on one or more of the ProSe capability related information of the UE, subscriber information of the UE, and operator policy information.

22. The method according to claim 20, wherein the ProSe related network providing information is stored in one or more of the network node, a Home Subscriber Server (HSS) and a ProSe server.

23. The method according to claim 13, wherein the information about ProSe permissibility of the UE is determined by at least one of the network node, a Home Subscriber Server (HSS) or a ProSe server, based on one or more of the ProSe capability related information of the UE, subscriber information of the UE, and operator policy information.

24. The method according to claim 13, wherein the information about ProSe permissibility of the UE is further stored in one or more of a Home Subscriber Server (HSS) and a ProSe server.

25. The method according to claim 13, wherein the first message is an attach request message, a Tracking Area Update (TAU) request message, or a Routing Area Update (RAU) request message.

26. The method according to claim 13, wherein the second message is Initial Context Setup Request message, an attach response message, a TAU response message, or a RAU response message received from the network node.

27. The method according to claim 13, wherein the network node is one of a Mobility Management Entity (MME), or a Serving GPRS (General Packet Radio Service) Supporting Node (SGSN).

28. A network node for supporting proximity service (ProSe) of a user equipment (UE) in a wireless communication system, the network node comprising:
a transceiver;
a processor; and
a memory,
wherein the processor is configured to:
control the transceiver to receive, from a base station of the UE, a first message including ProSe capability related information of the UE;
control the memory to store the ProSe capability related information; and
control the transceiver to transmit, to the base station of the UE, a second message including information about ProSe permissibility of the UE.
